(19) United States
(12) Patent Application Publication
(10) Pub. No.: US 2008/0170334 A1
(43) Pub. Date: Jul. 17, 2008

(54) Magnetic head

(75) Inventor: Mitsuru Otagiri, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/005,458

(22) Filed: Dec. 27, 2007

(30) Foreign Application Priority Data
Jan. 12, 2007 (JP) 2007-003944

(51) Int. Cl. G11B 5/33

(52) U.S. Cl. 360/313

(57) ABSTRACT

According to an aspect of an embodiment, a magnetic head comprises a magnetic pole; a first return yoke located under a lower side of the magnetic pole; a second return yoke located over an upper side of the magnetic pole; and a side yokes made of a soft magnetic material, located adjacently to the end of the magnetic pole and connecting the first return yoke and the second return yoke.

### BACKGROUND OF THE INVENTION

### Technical Field

The present invention relates a magnetic head. More specifically, the present invention pertains to a magnetic head including a magnetic pole, a first return yoke located under a lower layer side of the magnetic pole, and a second return yoke located over an upper layer side of the magnetic pole.

### SUMMARY

According to an aspect of an embodiment, a magnetic head comprises: a magnetic pole; a first return yoke located under a lower side of the magnetic pole; a second return yoke located over an upper side of the magnetic pole; and a side yokes made of a soft magnetic material, located adjacently to the end of the magnetic pole and connecting the first return yoke and the second return yoke.

According to an aspect of another embodiment, a magnetic head comprises: a magnetic pole; a first return yoke located under a lower side of the magnetic pole; a second return yoke located over an upper side of the magnetic pole; a trailing shield located on a lower side of the second return yoke; and a side yoke made of a soft magnetic material, located adjacently to the end of the magnetic pole and connecting the first return yoke and the trailing shield.

### BRIEF DESCRIPTION OF THE DRAWINGS

FIGS. 1A to 1D are diagrams each showing a configuration of a thin film magnetic recording head according to an embodiment, wherein FIG. 1A is a diagram of the thin film magnetic recording head as viewed from the air bearing surface (ABS) side, and FIGS. 1B to 1D are each sectional views of the thin film magnetic recording head cut away by a section orthogonal to the ABS;

FIGS. 2A and 2B are diagrams each showing a configuration of the thin film magnetic recording head according to another embodiment, wherein FIG. 2A is a diagram of the thin film magnetic recording head as viewed from the ABS side, and FIG. 2B is a sectional view of the thin film magnetic recording head cut away by a section orthogonal to ABS;

FIGS. 3A and 3B are diagrams each showing a configuration of the thin film magnetic recording head according to another embodiment, wherein FIG. 3A is a diagram of the thin film magnetic recording head as viewed from the ABS, and FIG. 3B is a sectional view of the thin film magnetic recording head cut away by a section orthogonal to ABS;

FIG. 4 is a diagram showing a configuration of a conventional thin film magnetic recording head;

FIGS. 5A to 5D are diagrams each showing a configuration of the conventional thin film magnetic recording head, wherein FIG. 5A is a diagram of the thin film magnetic recording head as viewed from the ABS side, and FIGS. 5B to 5D are each sectional views of the thin film magnetic recording head cut away by a section orthogonal to ABS;

FIG. 6 is a representation explaining an operation of a magnetic flux emitted from the thin film magnetic recording head on a magnetic recording medium;

FIGS. 7A and 7B are diagrams each showing a configuration of the conventional thin film magnetic recording head, wherein FIG. 7A is a diagram of the thin film magnetic recording head as viewed from the ABS side, and FIG. 5B is a sectional view of the thin film magnetic recording head cut away by a section orthogonal to the ABS; and

FIGS. 8A and 8B are diagrams each showing a configuration of the conventional thin film magnetic recording head, wherein FIG. 8A is a diagram of the thin film magnetic recording head as viewed from the ABS, and FIG. 8B is a sectional view of the thin film magnetic recording head cut away by a section orthogonal to the ABS.

### DESCRIPTION OF THE PREFERRED EMBODIMENTS

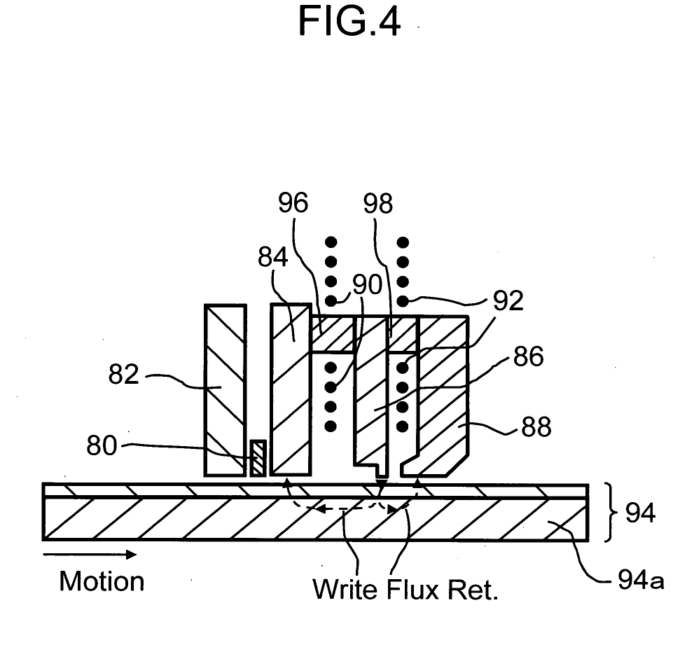

Hereinafter, the basic configuration of a thin film magnetic recording head will be described with the appended drawings. FIG. 4 is a diagram showing a configuration of a conventional thin film magnetic recording head.

The thin film magnetic recording head shown in FIG. 4 has a reading head including a read element 80, a lower shield 82 for the read element 80, and an upper shield 84 for the read element 80.

Also, this thin film magnetic recording head has a magnetic recording head including a recording magnetic pole (main magnetic pole) 86, a first return yoke 84 also serving as the upper shield 84, located under the lower layer side (leading side) of the recording magnetic pole 86, a second return yoke 88 located over the upper layer side (trailing side) of the recording magnetic pole 86, a first coil 90, and a second coil 92.

The recording magnetic pole 86, the first return yoke 84, and the second return yoke 88 are configured so that one end face of each of them is exposed to the ABS (surface opposed to a magnetic recording medium 94), and that the other end faces of them are connected to one another. As shown in FIG. 4, the recording magnetic pole 86 and the first return yoke 84 are connected at a connection portion 96, and the recording magnetic pole 86 and the second return yoke 88 are connected at a connection portion 98. There are provided a first coil 90 and a second coil 92 so as to surround the connection portions 96 and 98, respectively.

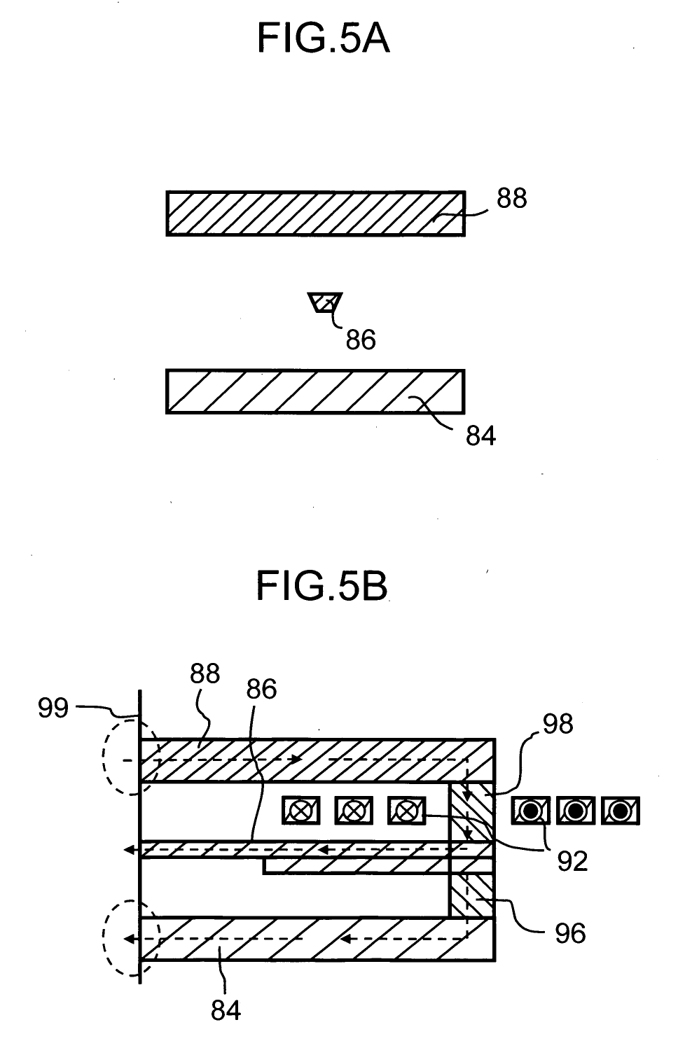

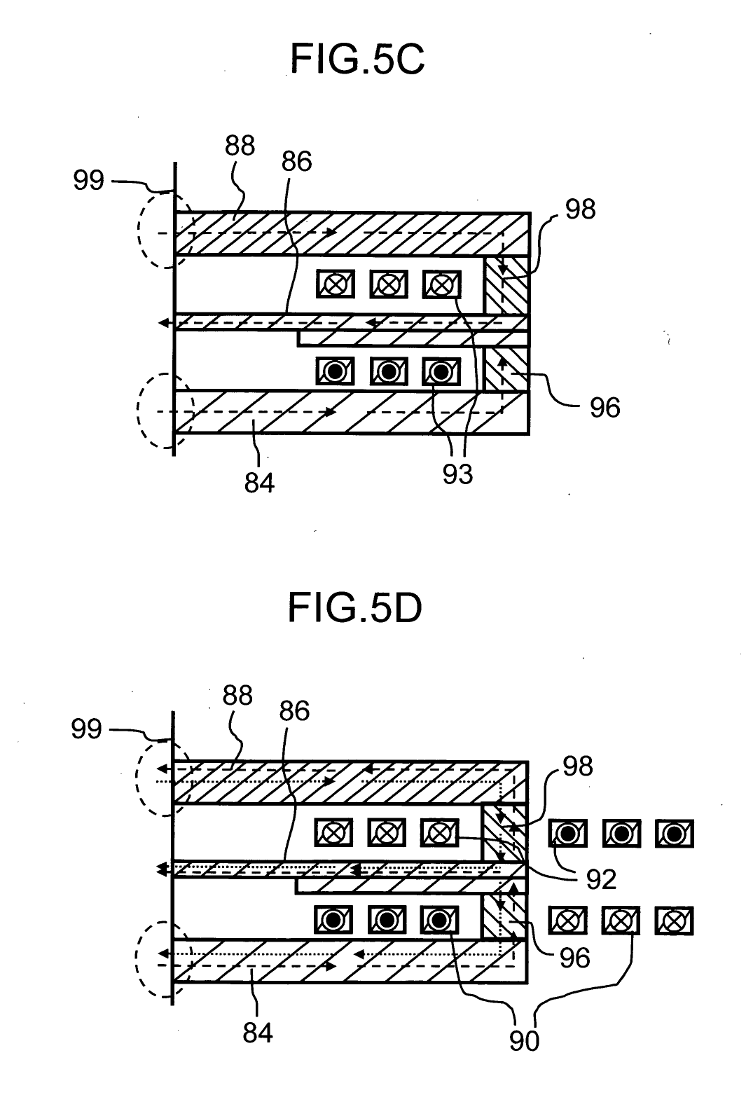

As shown in FIGS. 5B to 5D, ways of arranging coils include some variations. FIG. 5A is a diagram of the thin film magnetic recording head as viewed from the side of ABS 99, and FIGS. 5B to 5D are each sectional views of the thin film magnetic recording head cut away by a section orthogonal to the ABS 99. Here, blank portions in FIGS. 5A to 5D are portions filled by insulating films.

FIG. 5B shows a configuration in which the coil 92 is arranged around only one side connection portion 98 (on the side of the second return yoke 88).

FIG. 5C shows a configuration in which the coil 93 is wound around the recording magnetic pole 86. This configuration is generally referred to as a “helical type” or the like.

FIG. 5D shows a configuration in which the coils 90 and 92 are arranged around the two connection portions 96 and 98, respectively. This configuration is generally referred to as a “double coil type” or the like.

In FIGS. 5B to 5D, circle marks and cross marks indicate directions of electric currents applied to the coils 90, 92, and 93. The circle mark indicates that a current is directed toward the front side perpendicularly to the plane of the figure. On the other hand, the cross mark indicates that a current is directed toward the back side perpendicularly to the plane of the figure. Here, arrows each indicate the direction of a flow of a magnetic flux corresponding to the direction of current.

Here, the flow of a magnetic flux during the magnetization of a magnetic recording medium will be explained, taking, as an example, the helical coil type thin film magnetic recording head for perpendicular magnetic recording as shown in FIG. 5C. Applying a current as shown in FIG. 5C to the coil 93 of the helical coil type thin film magnetic recording head shown in FIG. 5C, generates, in the recording magnetic pole 86, magnetic fluxes in the directions indicated by arrows.

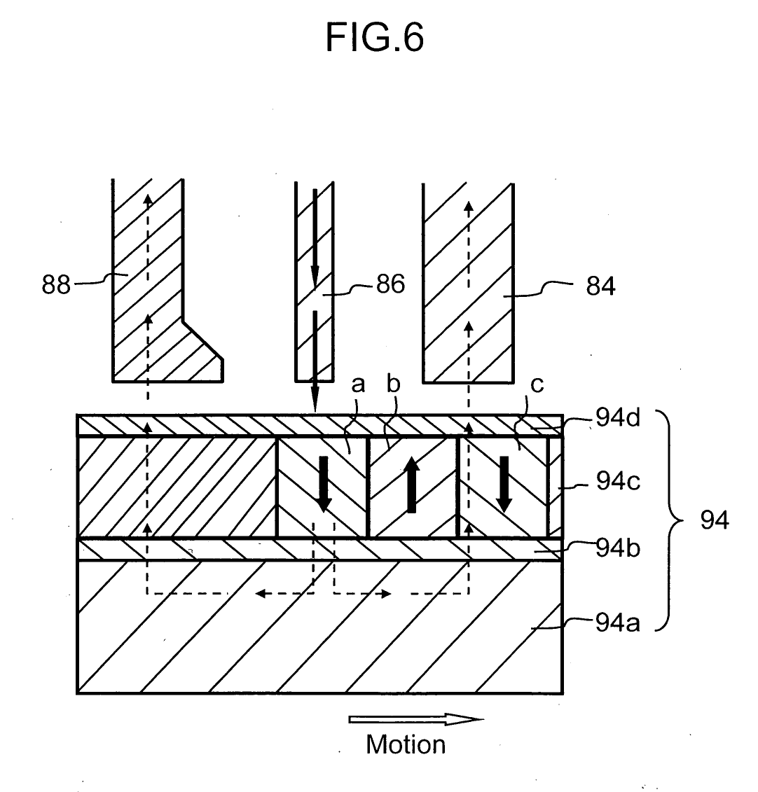

The operation of the magnetic flux on the magnetic recording medium 94 will be described with reference to FIG. 6.

The magnetic recording medium 94 is constituted by laminating, from the lower layer side, a soft magnetic layer 94a, an intermediated, layer 94b, a recording layer 94c having a predetermined coercive force, and a protective layer 94d. The magnetic flux emitted from the front end of the recording magnetic pole 86 passes through the protective layer 94d, the recording layer 94c, and the intermediated layer 94b to reach the soft magnetic layer 94a. Then, the magnetic flux returns to the first and second return yoke 84 and 88 of the thin film magnetic recording head, through the soft magnetic layer 94a.

Because the front end of the recording magnetic pole 86 is small in the cross-sectional area as shown in FIG. 5A, the density of magnetic flux (recording magnetic field) emitted from the front end of the recording magnetic pole 86 toward the magnetic recording medium 94 is very high. Also, the soft magnetic layer 94a and the recording magnetic pole 86 magnetically couple to each other, which performs a function of strengthening a magnetic flux (recording magnetic field) applied to the recording layer 94c. As a result, as shown in FIG. 6, a recording layer “a” of the magnetic recording medium 94 located in the closest proximity to the front end of the recording magnetic pole 86 is magnetized in the direction of the magnetic flux (recording magnetic field) emitted from the front end of the recording magnetic pole 86, and thus magnetic information is recorded by this magnetization state.

In the configuration shown in FIG. 5B, the magnetic flux is radiated from the recording magnetic pole 86 and the first return yoke 84 toward the magnetic recording medium as indicated by the arrows, and return via the second return yoke 88.

The configuration (double coil type) shown in FIG. 5D is intended to theoretically cancel magnetic fluxes to flow in the return yokes 84 and 88 in order to emit the magnetic flux from only the recording magnetic pole 86 toward the magnetic recording medium, by making mutually opposite the direction of a current applied to the coil 90 and that of a current applied to the coil 92. In FIG. 5D, an arrow shown by fine dotted lines indicates the direction of a magnetic flux occurring under the operation of the current applied to the coil 90, and an arrow shown by coarse dotted lines indicates the direction of a magnetic flux occurring under the operation of the current applied to the coil 92.

In each of the configurations shown in FIGS. 5A to 5D, inverting the direction of a current applied to each of the coils 90, 92, and 93, makes the direction of an occurring magnetic flux opposite to the direction of the arrow.

Hereinafter, a preferred embodiment for implementing a magnetic head according to the present invention will be described.

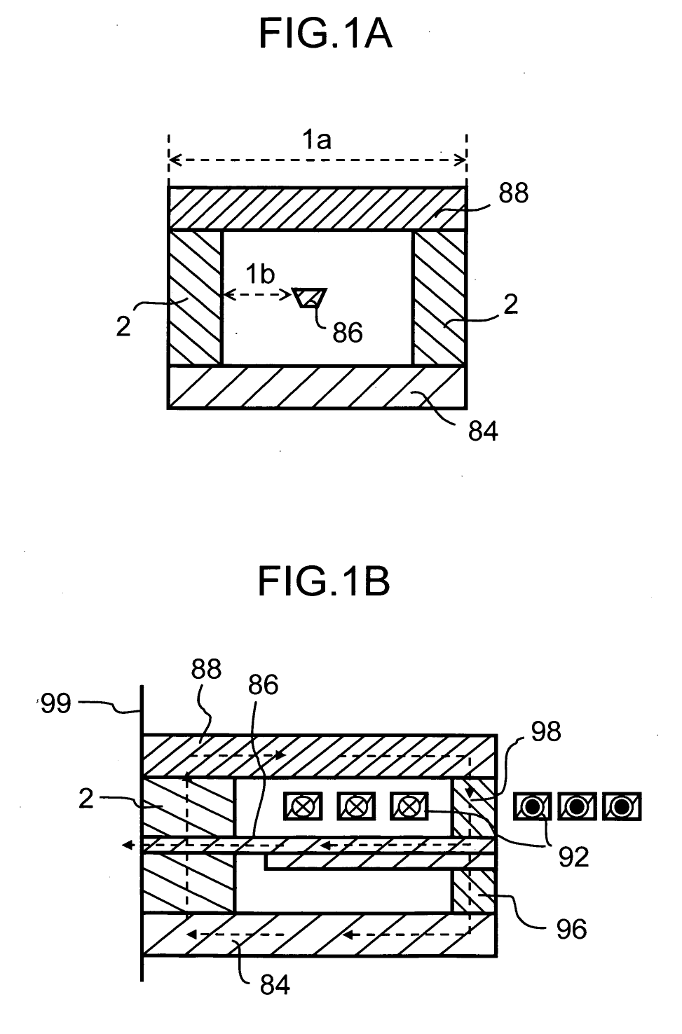

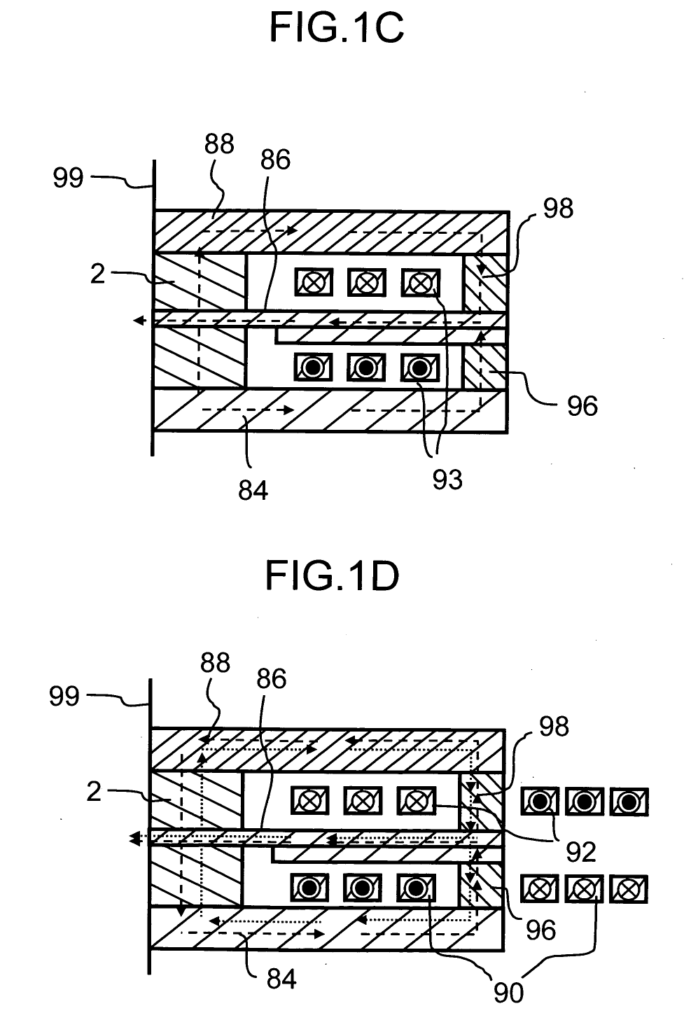

FIG. 1A to 1D are diagrams each showing a configuration of a thin film magnetic recording head for perpendicular magnetic recording according to the present embodiment, wherein FIG. 1A is a diagram of the thin film magnetic recording head as viewed from the side of ABS 99, and FIGS. 1B to 1D are each sectional views of the thin film magnetic recording head cut away by a section orthogonal to the ABS 99. Here, blank portions in FIGS. 1A to 1D are portions filled by insulating films.

FIG. 1B to 1D show variations of ways of arranging coils, as in the case of the above-described FIG. 5B to 5D.

Construction common to the variations of the thin film magnetic recording head as shown in FIG. 1B to 1D is described below.

The thin film magnetic recording head includes a recording magnetic pole (main magnetic pole) 86, a first return yoke 84 located under the lower layer side (leading side) of the recording magnetic pole 86, a second return yoke 88 located over the upper layer side (trailing side) of the recording magnetic pole 86.

The recording magnetic pole 86, the first return yoke 84, and the second return yoke 88 are configured so that one end face of each of them is exposed to the ABS 99 (surface opposed to the magnetic recording medium), and that the other end faces of them are connected to one another. As shown in FIG. 1B to 1D, the recording magnetic pole 86 and the first return yoke 84 are connected at the connection portion 96, and the recording magnetic pole 86 and the second return yoke 88 are connected at the connection portion 98.

Ways of arranging coils include some variations.

FIG. 1B shows a configuration in which the coil 92 is arranged around only one side connection portion 98 (on the side of the second return yoke 88).

FIG. 1C shows a configuration in which the coil 93 is wound around the recording magnetic pole 86 (“helical type” configuration).

FIG. 1D shows a configuration in which the coils 90 and 92 are arranged around the two connection portions 96 and 98, respectively (“double coil type” configuration).

FIGS. 1B to 1D illustrate the directions of electric currents applied to the coils 90, 92, and 93. The circle mark indicates that a current is directed toward the front side perpendicularly to the plane of the figure. On the other hand, the cross mark indicates that a current is directed toward the back side perpendicularly to the plane of the figure. Here, arrows each indicate the direction of a flow of a magnetic flux corresponding to the direction of current.

In FIG. 1A to 1D, a reading head is omitted, but, as in the case of the conventional thin film magnetic recording head (FIG. 4), a reading head including a lower shield, a read element, and an upper shield may be located on a further lower layer side than the first return yoke 84. In this case, the second return yoke 88 may be configured so as to also serve as an upper shield for the reading head, or alternatively, the second return yoke 88 may be formed independently of the upper shield for the reading head.

As shown in FIG. 1A, the magnetic head according to the present invention is characterized in that the side yokes 2 made of a soft magnetic material are located on both sides of the recording magnetic pole 86, the side yokes 2 being exposed to the ABS 99 and connecting the first return yoke 84 and the second return yoke 88.

The two side yokes 2 are preferably arranged so as to connect both end portions in the core width direction (the left and right direction on FIG. 1A), of the recording magnetic pole 86, of the first and second return yokes 84 and 88 that are exposed to the ABS 99.

While not particularly limited, it is recommendable that the spacing 1b between the recording magnetic pole 86 and each of the side yokes 2 is set to about 10 to 100 μm. The width 1a in the core width direction of the recording magnetic pole 86 of the first and second return yokes 84 and 88 that are exposed to the ABS 99, is generally on the order of 50 to 100 μm.

In FIGS. 1B to 1D, although the side yoke 2 is not present on the same cross-section as that of the recording magnetic pole 86, they are represented on these sectional views for the sake of the explanation of routes of magnetic fluxes. As shown in FIGS. 1B to 1D, the side yoke 2 is arranged so as to connect the end portions on the side of the ABS 99, of the first and second return yokes 84 and 88. The side yoke 2 is disposed more adjacently to the ABS 99 than the coils 90, 92, and 93.

The material of the side yokes 2 is not particularly limited as long as it is a soft magnetic material; one example thereof is Permalloy.

In the thin film magnetic recording head according to the present embodiment, as shown by the arrows in FIG. 1B to 1D, the first return yoke 84 and the second return yoke 88 are connected on the side of the ABS 99 to thereby form an endless shape (o-type shape). Accordingly, the thin film magnetic recording head according to the present embodiment has a closed structure as a magnetic circuit, and hence, as shown by the arrows in the figures, the magnetic field thereof becomes less prone to be emitted (i.e., to leak) from the side of the ABS 99, of the first return yoke 84 and the second return yoke 88.

Furthermore, as shown in FIG. 1A, the area of the soft magnetic body connected to the first return yoke 84 and the second return yoke 88, and exposed to the ABS 99 is larger by the areas of the side yokes 2. As a consequence, even if a magnetic flux is emitted from the side of the ABS 99, of the first return yoke 84 and the second return yoke 88, the magnetic flux density thereof becomes low.

Moreover, as shown in FIG. 1A, the shape in which the first and second return yokes 84 and 88 and the side yokes 2 are exposed to the ABS 99 becomes an endless shape. This makes the magnetic field less prone to be emitted from the side of the ABS 99, of the first return yoke 84 and the second return yoke 88.

Therefore, during magnetic recording, it can be prevented that, as is conventionally done, magnetic fields emitted from the first and second return yokes 84 and 88 undesirably erase magnetic information that has already been recorded in a magnetic recording medium, or weaken the magnetization state.

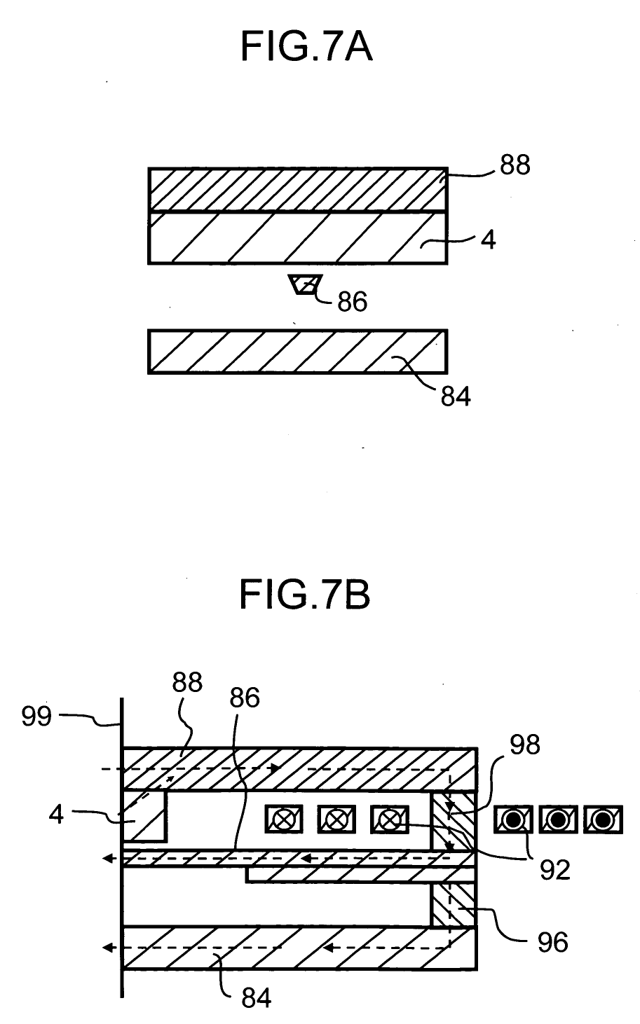

In the thin film magnetic recording head, conventionally, for the purpose of realizing a high magnetic field gradient to thereby enhance the recording density with respect to a magnetic recording medium, there have been cases where a trailing shield 4 connected to the second return yoke 88 is provided, as shown in FIGS. 7A and 7B, at the end portion on the side of the ABS 99, of the second return yoke 88 on the trailing side.

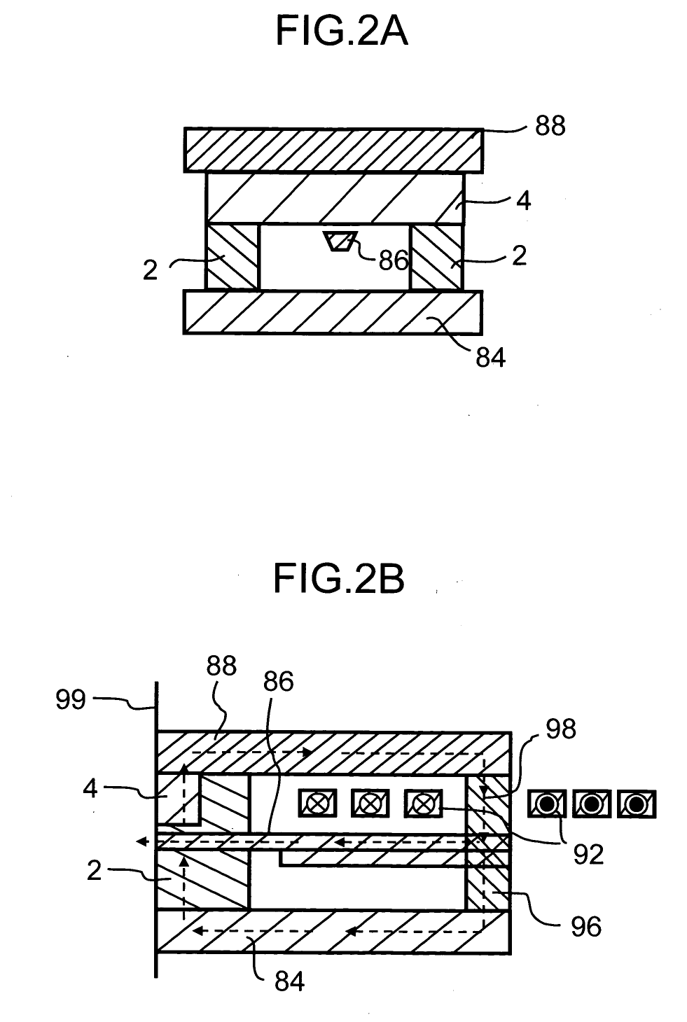

When the present invention is applied to the thin film magnetic recording head having such a trailing shield 4, the side yokes 2 are located so as to connect the first return yoke 84 and the trailing shield 4 as shown in FIGS. 2A and 2B. As shown in FIG. 2B, the side yokes 2 may be each arranged so as to be across both of the second return yoke 88 and the trailing shield 4, or alternatively, the side yokes 2 may be each arranged so as to be connected to the trailing shield 4 alone.

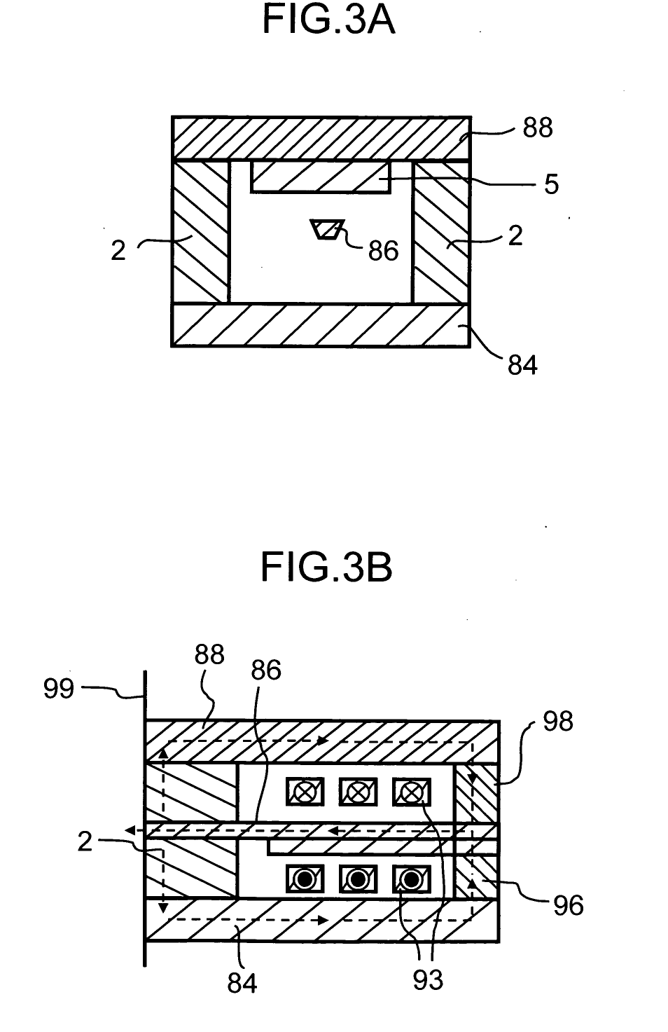

Even with the thin film magnetic recording head having the trailing shield, in a configuration in which a trailing shield 5 is located over an intermediate portion of the second return yoke 88 in the core width direction as shown in FIGS. 3A and 3B, the side yokes 2 may be arranged so as to connect the first return yoke 84 and the second return yoke 88.

As a production method for the thin film magnetic recording head according to the present embodiment, for example, the following method can be used. First, the first return yoke 84, the recording magnetic pole 86, the coils 90, 92 and 93, the connection portions 96 and 98, and insulating layers filling portions between these, are each formed by lamination. Next, longitudinal holes in the lamination direction (this is realized, e.g., by ion milling with a resist layer used as a mask) are formed in the insulating layers in the areas corresponding to the side yokes 2, and the longitudinal holes are filled with Permalloy by plating, thereby forming the side yokes 2. Thereafter, the second return yoke 88 (or trailing shield 4) is formed on the side yokes 2 and the insulating layer.

Alternatively, this thin film magnetic recording head may be formed by using a method in which the plating performed when the connection portions 96 and 98 and the recording magnetic pole 86 are formed, is applied also to the areas corresponding to the side yokes 2, to thereby pile up the side yokes 2 from the lowest layer.

Hitherto, techniques have been proposed for reducing magnetic field leakage from the recording magnetic pole toward the track width direction, and preventing the erasure of adjacent tracks (i.e., side track erasure) by providing side shields on the both sides of the recording magnetic pole (main magnetic pole).

Here, regarding the side yoke according to the present invention and the conventional side shield, the difference between them will be described for the purpose of avoiding confusion between them.

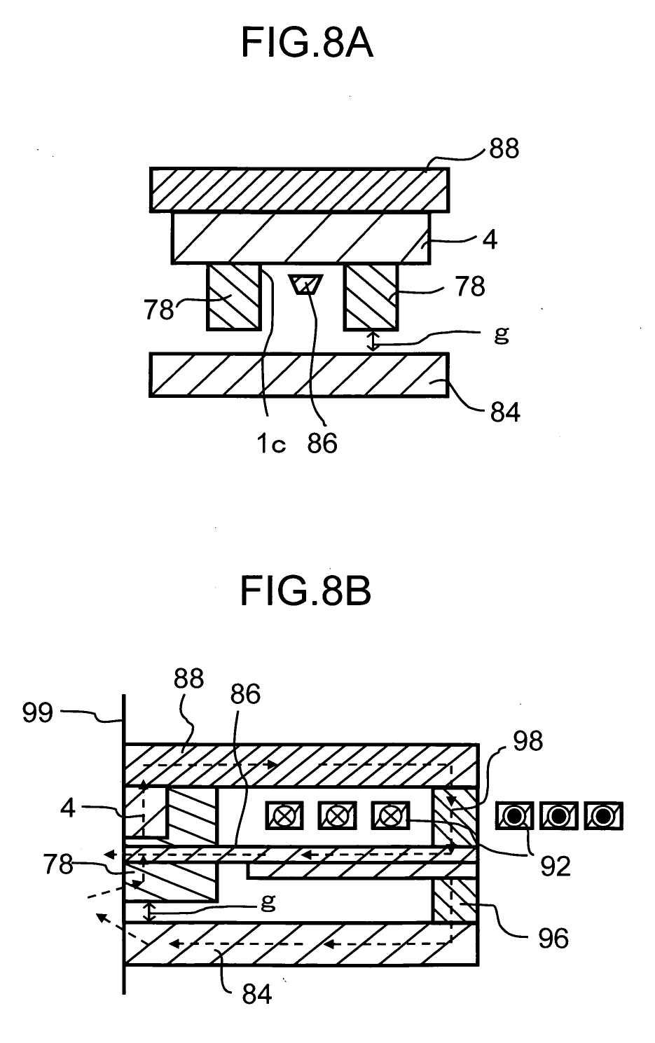

FIGS. 8A and 8B are diagrams each showing a configuration of a thin film magnetic recording head with the conventional side shields, wherein FIG. 8A is a diagram thereof as viewed from the ABS side, and FIG. 8B is a sectional view of this thin film magnetic recording head cut away by a section orthogonal to the ABS. In FIG. 8B, although the side shield 78 is not present on the same cross-section as that of the recording magnetic pole 86, they are represented on this sectional view for the sake of the explanation of routes of magnetic fluxes. Here, the same components as those in the above-described embodiment are designated by the same symbols, and description thereof is omitted.

In FIGS. 8A and 8B, side shields 78 are located on both sides of the recording magnetic pole 86. The conventional side shields 78 are, as described above, located for the purpose of preventing the erasure of adjacent tracks (side track erasure).

Structurally, a gap g between which an insulating layer is interposed is located between the side shields 78 and one of the return yokes (first return yoke 84). In the vicinity of this gap g, the gap g is prone to increase the magnetic field emitted (leaking) from the first return yoke 84 toward the magnetic recording medium.

Since the side shields 78 are located for the purpose of preventing the erasure of adjacent tracks, the spacing 1c between the side shield 78 and the recording magnetic pole 86 is a spacing (about 0.02 to 0.2 μm) commensurate with a track-to-track spacing. This spacing is significantly different from the spacing (about 10 to 100 μm) between the recording magnetic pole 86 and the side yoke 2 in the present embodiment.

As described above, the conventional side shields 78 are not ones that connect the first return yoke 84 and the second return yoke 88 (or trailing shield 4 connected to the second return yoke 88). Furthermore, the arrangement of the conventional side shields 78 also differs from that of the side yokes in the present embodiment.

In the thin film magnetic recording head with the conventional side shields, from the foregoing constructional difference from the present embodiment, there occurs an operational difference therefrom such that the magnetic field leaking from the return yokes is increased by the above-described gap g, leading to the opposite effect.

What is claimed is:

1. A magnetic head comprising:
a magnetic pole;
a first return yoke located under a lower side of the magnetic pole;
a second return yoke located over an upper side of the magnetic pole; and
a side yoke made of a soft magnetic material, located adjacently to the end of the magnetic pole and connecting the first return yoke and the second return yoke.

2. A magnetic head according to claim 1, wherein the side yoke connects one end of the first return yoke and one end of the trailing shield.

3. A magnetic head according to claim 1, wherein the magnetic head having a closed structure including the first return yoke, the second return yoke and the side yoke as a magnetic circuit.

4. A magnetic head according to claim 1, wherein the side yokes are located on both sides of the magnetic pole, respectively.

5. A magnetic head according to claim 1, wherein the spacing between the magnetic pole and the side yoke is about 10 to 100 μm.

6. A magnetic head comprising:
a magnetic pole;
a first return yoke located under a lower side of the magnetic pole;
a second return yoke located over an upper side of the magnetic pole;
a trailing shield located on a lower side of the second return yoke; and
a side yoke made of a soft magnetic material, located adjacently to the end of the magnetic pole and connecting the first return yoke and the trailing shield.

7. A magnetic head according to claim 6, wherein the side yoke connects one end of the first return yoke and one end of the trailing shield.

8. A magnetic head according to claim 6, wherein the magnetic head having a closed structure including the first return yoke, the second return yoke, the trailing shield and the side yoke as a magnetic circuit.

9. A magnetic head according to claim 6, wherein the side yokes are located on both sides of the magnetic pole, respectively.

10. A magnetic head according to claim 6, wherein the spacing between the magnetic pole and the side yoke is about 10 to 100 μm.
